(19) United States
(12) Patent Application Publication
(10) Pub. No.: US 2009/0312040 A1
(43) Pub. Date: Dec. 17, 2009

(54) System and method for inserting advertisements into SMS messages

(75) Inventors: Shekhar Gupta, Overland Park, KS (US); Mike A. Roberts, Overland Park, KS (US); Michael Robinson, Overland Park, KS (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: EMBARQ HOLDINGS COMPANY, LLC

(21) Appl. No.: 12/139,196

(22) Filed: Jun. 13, 2008

(51) Int. Cl. G06Q 30/00; H04Q 7/20

(52) U.S. Cl. 455/466

(57) ABSTRACT

A method and system for inserting advertisements into text messages includes receiving a text message for delivery to a user. One or more keywords received in the text message may be identified. An advertisement may be associated with the identified one or more keywords. The associated advertisement may be sent to the user with the text message.

### BACKGROUND OF THE INVENTION

Cellular telephones are no longer solely used to provide voice communications. One increasingly popular use for cellular phones is known as text messaging or SMS messaging. Initially based on a communications protocol known as “Short Message Service” (SMS), today several different protocols can be used to send text messages, such as “Multi Media Messaging Service” (MMS). Regardless of the protocol, text messages are still frequently referred to as SMS. The name given a text message also tends to vary by location with certain countries or locations preferring one name over another.

In the past decade, text messaging has quickly caught on as an alternative to making a telephone call. A text message is a short (generally up to 160 characters) message that is displayed on a cellular phone or other electronic device. If the text message is longer than 160 characters, depending upon the protocol, the text message may be broken into smaller segments and sent separately. The smaller segments may then be combined at the receiving device into a single message.

Text messaging has proven to be lucrative for service providers. Often a charge per message is incurred or a user may purchase a bundle including a set number of text messages that may be sent or received. More recently, some pricing packages with “unlimited minutes” allow for unlimited talk time for users and may include unlimited text messaging as well. Regardless of the possibility for unlimited text messaging within a package plan, text messaging provides a tangible benefit for users and may provide for potential revenue generation in other ways for the service providers.

“Add-ons,” such as a charge for each text message or a bundle package of text messages, can make a user's bill seem unbearable. Everything from exceeding the number of minutes a person has to talk on their service plan or using excessive text messages can increase the amount that is owed each month.

### BRIEF SUMMARY OF THE INVENTION

In order to provide a user with the most cost effective services while maximizing revenue for their service provider, advertisements may be inserted into text messages. By providing targeted user specific or keyword specific advertisements to a user, the likelihood of an advertiser receiving business from the advertisement may be increased over random advertisement insertion. User demographics, location of the user, and/or keywords within the text message may be used to target advertisements to customers, thus providing relevant advertisements to the customers. Additionally, agreeing to receive advertisements by “opting-in” or selecting a plan which provides for the advertisements may allow a user to receive discounted service and result in lower bills each month.

One embodiment includes a method for inserting advertisements into text messages. The method includes receiving a text message for delivery to a user. One or more keywords received in the text message may be identified. An advertisement may be associated with the identified one or more keywords. The associated advertisement may be sent to the user with the text message.

### BRIEF DESCRIPTION OF THE DRAWINGS

Illustrative embodiments of the present invention are described in detail below with reference to the attached drawing figures, which are incorporated by reference herein and wherein:

FIG. 1 is an illustration of an exemplary environment for inserting a targeted advertisement into an SMS message;

FIG. 2 is a block diagram of exemplary components of a server configured to facilitate inserting a targeted advertisement into an SMS message;

FIG. 3 is a block diagram of exemplary modules for inserting a targeted advertisement into an SMS message; and

FIG. 4 is an illustration of an exemplary screen shot depicting principles of the present invention.

FIG. 5 is a flow chart of an exemplary process for inserting a targeted advertisement into an SMS message in accordance with the principles of the present invention.

### DETAILED DESCRIPTION OF THE INVENTION

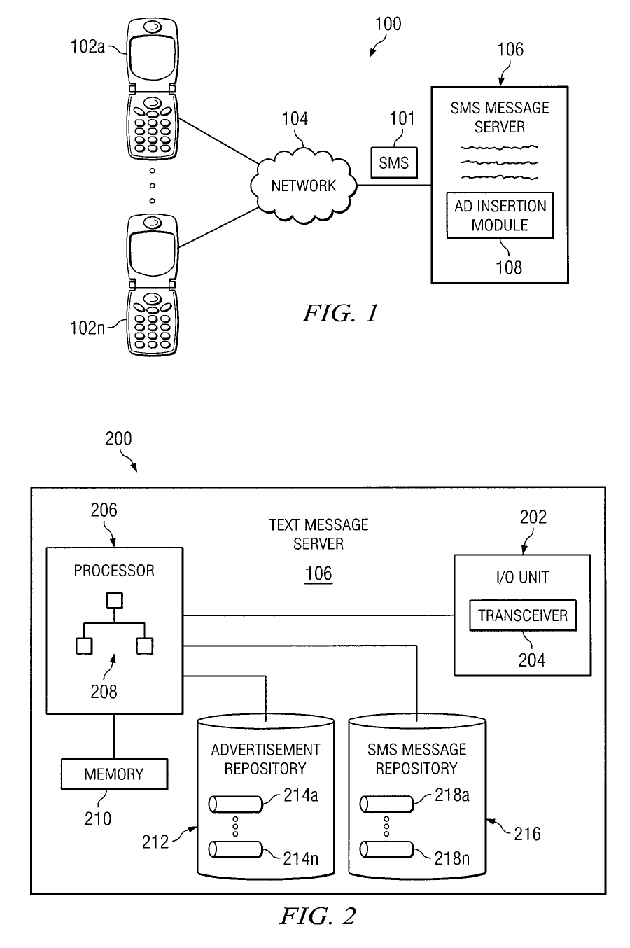

FIG. 1 is an illustration of an exemplary environment 100 for inserting a targeted advertisement into an SMS message 101. For purposes of the specification, an “SMS message,” “SMS,” and “text message” may be used interchangeably throughout the specification and are intended to refer to the same data being communicated via a network between communications devices. By “inserting” an advertisement into an SMS message, an advertisement may be appended prior to, within, or after an SMS message. The advertisement may also be inserted into a separate SMS message upon a request for additional information from an SMS message recipient. The advertisement may be accessed from an advertisement repository or saved in the same repository as the SMS message. In one embodiment, mobile telephone customers 102a-102n (collectively 102) may communicate over a network 104 in which an SMS message server 106 may also be in communication. Within the SMS message server 106 may be an ad insertion module 108 capable of inserting ads in or sending a text message in performing the principles of the present invention.

An example of a mobile telephone customer 102 may be a subscriber of a cellular service provider, but may be a subscriber to any type of mobile service capable of receiving an SMS message 101. Exemplary mobile devices may include a smart phone, personal digital assistant (PDA), traditional mobile telephone, or any other type of mobile electronic device. In alternative embodiments, other telephone devices may include cordless telephones, Voice over Internet Protocol (VOIP) telephones, computer with communication devices, such as a microphone and speakers attached (i.e., soft-phone), or any other device configured to communicate with the network 104 and provide or receive SMS messaging services.

The network 104 may be a PSTN, the Internet, any type of cellular network such as GSM, CDMA, TDMA, and UMTS, or any other type of network configured to communicate with the SMS message server 106 and communicate an SMS message 101.

The SMS message server 106 may be any server or device configured to process SMS message communications and to communicate an SMS message 101 over the network 104. For example, if the network is a PSTN, the SMS message server 106 may be located at a central office (CO). In another embodiment, the network may be the Internet and the SMS message server 106 may be anywhere with a connection to the Internet. These are just two examples of many that would be considered in the scope of the invention.

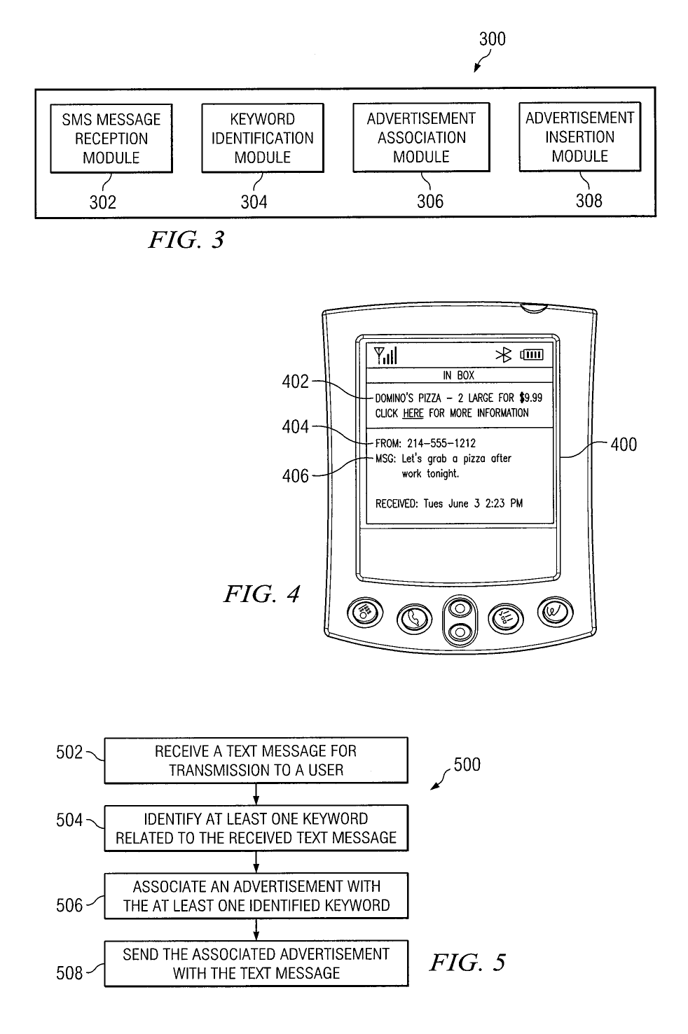

The advertisement insertion module 108 may be located within the SMS message server 106 and may be configured to control the insertion of advertisements into the SMS message 101. The advertisement insertion module 108 may include any combination of hardware or software. The advertisement insertion module 108 is described below in greater detail in FIG. 3.

FIG. 2 is a block diagram of exemplary components 200 of SMS message server 106 of FIG. 1 configured to facilitate inserting a targeted advertisement into an SMS message. The SMS message server 106 may include an input/output (I/O) unit 202 for receiving and communicating an SMS message. The I/O unit 202 may additionally include a transceiver 204 for transmitting an SMS message to a user and for receiving an SMS message from the network. The SMS message server 106 may also include a processor 206 for processing the SMS message. The processor 206 may execute software 208 capable of performing the functionality of the SMS message server 106. Software modules that operate in the software 208 are described below in more detail in reference to FIG. 3. Memory 210 may also be located within the SMS message server 106 for storing data being processed by the processor 206. An advertisement repository 212 may also be included in or be in communication with the SMS message server 106. The advertisement repository 212 may be a hard drive or any other type of volatile or non-volatile memory capable of storing advertisement data. Within the advertisement repository 212 may be one or more data repositories 214a-214n, such as a database or multiple databases, capable of storing and organizing data, such as advertisements. In one embodiment, rather than including the advertisement repository 212, the SMS message server 106 may use a memory 210 that is large enough to store a sufficient number of advertisements.

Similarly, an SMS message repository 216 may also be included in the SMS message server 106. The SMS message repository 216 may be a hard drive or any other type of volatile or non-volatile memory capable of storing SMS messages. Within the SMS message repository 216 may be one or more data repositories 218a-218n, such as a database, or multiple databases, capable of storing and organizing data, such as voice messages. In one embodiment, rather than including the SMS message repository 216, the SMS message server 106 may use the memory 210 to store the SMS messages.

FIG. 3 is a block diagram of exemplary modules 300 configured to insert targeted advertisements into SMS messages. A targeted advertisement is an advertisement that has some relationship to content (e.g., words) within an SMS message. For example, if the word “pizza” is located within the SMS message message, an advertisement for a pizza restaurant may be inserted into the SMS message. The modules 300 are exemplary in nature and are not intended to limit the scope of the invention. In one embodiment the modules 300 may be software modules configured to operate on the processor 208 within an SMS message server 106. One module is an SMS message reception module 302. The SMS message reception module 302 may provide the functionality necessary for receiving an SMS message received by the SMS message server 106. The SMS message reception module 302 may control the I/O unit (similar to 202 in FIG. 2) to allocate memory for storing the SMS message, provide the mapping necessary for linking a received SMS message to a recipient, and provide the actual reception and distribution abilities of the SMS message server, among other functions. The received SMS message may be stored long-term or temporarily while the SMS message is being processed in other modules, such as the keyword determination module 304 and advertisement association module 306. The SMS reception module 302 may receive the SMS message at any stage of communication occurring within reach of the SMS Message server 106 and before the SMS message is sent for delivery to a recipient.

The keyword identification module 304 may provide for identification and selection of one or more relevant keywords or topics relating to an SMS message. Any number of methods may be used for determining or identifying the one or more keywords or topics. In one embodiment, an SMS message may be analyzed by segmenting the text into tokens, such as words or phrases, and analyzing the tokens for keywords or topics. If a particular word is used or if multiple occurrences of the same word occurs, the word or repeated word may be identified as a related keyword.

The selected keyword(s) may be correlated with keywords from the targeted advertisements to identify the most relevant targeted advertisements to associate with the SMS message. More specifically, the identified keyword or keywords from the keyword identification module 304 may then be used by the advertisement association module 306 to select an appropriate advertisement for sending with the SMS message. The advertisement association module 306 may include a table or another software tool that associates keywords or topics with certain advertisements. For example, a table may be set up providing a list of advertisement keywords and topics in one column with a pointer to, or the actual advertisement provided in, another column. An example is provided below in TABLE 1.

TABLE 1

| Advertisement Keywords | Advertisement |
|---|---|
| food, restaurant, drinks, | KFC-1, KFC-2, Kroger |
| meal, pizza, burger | |
| car, tires, taxi, ride | Honda, Jiffy Lube-1, Jiffy Lube-2 |
| vacation, travel, flight | American Airlines, Expedia, |
| | Walt Disney World |
| default | Turbo Tax, Supercuts |

When the identified keyword or keywords are communicated to the advertisement association module 306, the selection of a targeted advertisement may be made. If a match is made between the identified keyword of an SMS message and the list of advertisement keywords, the related advertisement may be associated with the SMS message, and then sent to the recipient when advertisement insertion module 308 is executed. Each keyword may have an associated weighting value to cause different keywords to be more heavily weighted than others (e.g., pizza=4, dinner=3), as different words tend to be more categorically specific than others.

Also depicted in TABLE 1 is the concept that more than one advertisement might pertain to the advertisement keywords and advertisements may be from the same or different vendors or companies. In this case, an advertisement may be selected at random or in a queue-type scheme where the selected advertisement is rotated, allowing for the advertisement to be selected equally.

Statistics may be compiled and updated as the advertisements are selected to enable the advertisements to be selected in accordance with any preferences, such as equal advertisement selection described previously, or if one vendor is preferred over others, the advertisements for that vendor may be provided more often than others. Another use for the statistics may be to keep track of the number of times an advertisement is used in the event a price-per-use schema is employed, or for any number of other reasons.

If no advertisement keyword is found that is identified to be a relevant match to the identified keyword, a set of default advertisements may be associated with the SMS message. These types of default advertisements may have a wide audience appeal or may be of the type that would not necessarily benefit by specific targeting.

The advertisement association module 306 may provide real-time association with the advertisement keyword and the SMS message keyword or may provide the advertisement association at the time that a SMS message is eventually delivered (such as when an SMS message is stored in a queue and delivered at a later time). In the case of the advertisement association module 306 being executed for an SMS message that is to be stored for later delivery, a method for keeping track of the associated advertisement with the SMS message may be provided. In an exemplary embodiment, a unique ID number may be associated with each advertisement, and may be stored along with the SMS message for sending together when the SMS message is eventually delivered.

In addition to keyword usage, the advertisement association module 306 may also be configured to associate an advertisement with an SMS message based on the demographics of a recipient of the SMS message. Demographics may be very useful when used alone or in combination with an identified keyword for picking the most relevant advertisement for the recipient. Demographic data may already be known for the recipient by a service provider if the recipient is also a customer of the service provider. The demographic information may also be located by the use of the Internet, external databases, or any other type of method. An exemplary demographic repository (not shown) may contain demographic information related to recipients of the SMS message. Some examples include age, gender, location, marital status, children, or any other demographic information.

One demographic data element that may be used is the location of the recipient. By determining where the recipient is located, advertisements for local advertisers may be provided, allowing for the most relevant advertisements to be selected by keyword, location, or both. Another location that may be associated with the recipient may be a location or destination that is mentioned in the SMS message. An example would be if the SMS message mentions an upcoming trip to Orlando and asks to have dinner one night—not only can a restaurant advertisement be provided, but an advertisement for restaurants specifically with locations in Orlando can be provided.

The advertisement insertion module 308 may insert the associated advertisement within the SMS message. The associated advertisement may be inserted or provided within the same SMS message, before content of the SMS message, or after the SMS message content. The advertisement may be interactive and provide a way to access additional information to the recipient upon request. For example, after seeing an advertisement for a restaurant, the SMS message may provide a selectable hyperlink indicating that the user can “click here for additional information.” Other options that may be provided enable a user to create a reservation, submit an order, set an appointment, request directions, or any number of other alternatives. The information may be immediately provided to the recipient through a website (if that format is available on the mobile device) or may be provided in a subsequent communication to the recipient. The additional information may be in any form, including those not accessible on the mobile device, audiovisual content, e-mail, postal mail, actual telephone call from a vendor or company (e.g., restaurant), or voicemail, just to name a few examples.

In addition to the advertisement, a digital coupon may be inserted along with the text message or sent in a subsequent text message. The digital coupon may be automatically inserted into the text message or may be provided upon the request of the user. The digital coupon may be displayed to a vendor at the time of redemption, may be sent to an e-mail address for printing, or may be accessed and displayed in any number of ways.

FIG. 4 is an illustration of an exemplary screen shot 400 depicting principles of the present invention. The screen shot 400 may be viewed on any mobile or electronic device capable of receiving an SMS message. An advertisement 402 may be displayed in addition to the information that would normally be displayed within an SMS message, such as the sender 404 and the message 406. The advertisement 402 may be selected using the methods described above in FIGS. 2 and 3. The advertisement 402 may provide general information, give directions or contact information, include a hyperlink for additional information, enable scheduling of a reservation, display a map, or provide any other information as described herein. The sender 404 may display the name of the sender or, if the name is not known, display the telephone number, as is commonly known in the art. The message 406 and sender 404 information may be used to target the advertisements, as also described previously.

FIG. 5 is a flow chart of an exemplary process 500 for inserting targeted advertisements into SMS messages in accordance with the principles of the present invention. In step 502, an SMS message may be received for transmission to a user. The SMS message may be received by a sender's service provider with the advertisement inserted by the sender's service provider. Alternatively, the advertisement may be inserted by a recipient's service provider, when it is received by the recipient's service provider.

In step 504, identification of one or more keywords related to the SMS message may occur. The one or more keywords may be identified by recognizing unique words, repeated words, or using any number of other techniques to identify words within the SMS message.

In step 506, an advertisement may be associated with the at least one identified keyword. In one embodiment, the association of the advertisement may be based on a list of categorized advertisements with keywords being associated with the various categories. In addition to the use of the keywords, other criteria may also be used in associating the advertisement selection with the identified keyword, such as location of the user or locations found in the SMS message. In one embodiment, area code or area code and exchange code of the telephone number(s) associated with the text messages may identify the location of the sender and receiver users.

In step 508, the associated advertisement is sent with the SMS message. In an exemplary embodiment, the advertisement is sent before the content of the SMS message to better ensure that a user views the advertisement, but the advertisement may be anywhere within the communication, such as after the SMS message, or even may be sent separately as described above.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed as new and desired to be protected by Letters Patent of the United States is:

1. A method for inserting a targeted advertisement in a text message, said method comprising:
receiving a text message for transmission to a user;
identifying at least one keyword related to the received text message;
associating an advertisement with the at least one identified keyword; and
sending the associated advertisement with the text message.

2. The method according to claim 1, wherein sending the associated advertisements includes inserting a selectable hyperlink in the text message.

3. The method according to claim 2, further comprising in response to the user selecting the selectable hyperlink within the text message, providing a user interface to enable the user to create a reservation.

4. The method according to claim 2, further comprising, in response to the user selecting the selectable hyperlink within the text message, providing a user interface to enable the user to submit an order.

5. The method according to claim 1, further comprising compiling statistics, the statistics including at least the number of times a particular advertisement is inserted into text messages.

6. The method according to claim 1, further comprising inserting a digital coupon within the text message.

7. The method according to claim 1, wherein associating an advertisement with the at least one identified keyword further includes analyzing demographics of the user.

8. The method according to claim 1, further comprising enabling the user to selectably request additional information associated with the advertisement to be delivered to the user.

9. The method according to claim 8, wherein the additional information associated with the advertisement includes audiovisual content.

10. The method according to claim 1, wherein sending the associated advertisements includes sending text of the advertisement with the text message.

11. A system for inserting a targeted advertisement in a text message, said system comprising:
a network element configured to:
receive a text message for transmission to a user;
identify at least one keyword related to the received text message;
associate an advertisement with the at least one identified keyword; and
send the associated advertisement with the text message.

12. The system according to claim 11, wherein the network element, in sending the associated advertisements, inserts a selectable hyperlink in the text message.

13. The system according to claim 12, wherein the network element is further configured to provide a user interface to enable the user to create a reservation in response to the user selecting the selectable hyperlink within the text message.

14. The system according to claim 12, wherein the network element is further configured to provide a user interface to enable the user to submit an order in response to the user selecting the selectable hyperlink within the text message.

15. The system according to claim 11, wherein the network element is further configured to compile statistics, the statistics including at least the number of times a particular advertisement is inserted into text messages.

16. The system according to claim 11, wherein the network element is further configured to insert a digital coupon within the text message.

17. The system according to claim 11, wherein the network element, in associating an advertisement with the at least one identified keyword, is further configured to analyze demographics of the user.

18. The system according to claim 11, where the network element is further configured to enable the user to selectably request additional information associated with the advertisement to be delivered to the user.

19. The system according to claim 18, wherein the additional information associated with the advertisement includes audiovisual content.

20. The system according to claim 11, wherein the network element, in sending the associated advertisements, is further configured to send text of the advertisement with the text message.
